(19) United States
(12) Patent Application Publication
(10) Pub. No.: US 2026/0091396 A1
(43) Pub. Date: Apr. 2, 2026

(54) AEROSOL IONIZATION DEVICE AND AIR PURIFIER EMPLOYING SAME

(71) Applicant: SAMSUNG ELECTRONICS CO., LTD., Suwon-si (KR)

(72) Inventors: Sekwan JEONG, Suwon-si (KR); Dongwoo WOO, Suwon-si (KR); Geunyeong PARK, Suwon-si (KR); Soyoung YUN, Suwon-si (KR); Youngchul KO, Suwon-si (KR)

(73) Assignee: SAMSUNG ELECTRONICS CO., LTD., Suwon-si (KR)

(21) Appl. No.: 19/413,802

(22) Filed: Dec. 9, 2025

Related U.S. Application Data
(63) Continuation of application No. PCT/KR2024/005686, filed on Apr. 26, 2024.

(30) Foreign Application Priority Data
Jun. 14, 2023 (KR) 10-2023-0076419

(51) Int. Cl. B03C 3/41; B03C 3/12; B03C 3/60; B03C 3/66; B03C 3/86

(52) U.S. Cl. CPC B03C 3/41; B03C 3/12; B03C 3/60; B03C 3/66; B03C 3/86; B03C 2201/04

(57) ABSTRACT

An aerosol ionization device including a discharge electrode and a counter electrode. The discharge electrode includes a spun yarn including electrically-conductive metal staple fibers. Ends of at least some of the electrically-conductive metal staple fibers protrude from a surface of the spun yarn. The counter electrode faces the discharge electrode with a gap therebetween.

### CROSS-REFERENCE TO RELATED APPLICATION

This application is a continuation application, under 35 U.S.C. § 111 (a), of international application No. PCT/KR2024/005686, filed Apr. 26, 2024, which claims priority under 35 U. S. C. § 119 to Korean Patent Application No. 10-2023-0076419, filed Jun. 14, 2023, the disclosures of which are incorporated herein by reference in their entireties.

### TECHNICAL FIELD

Embodiments of the present disclosure relate to an aerosol ionization device and an air purifier employing the same.

### BACKGROUND ART

An air purifier is a device that intakes contaminated air, purifies the air, and then discharges the purified air. The air purifier may include an aerosol ionization device and a dust collector. The dust collector may include an electric dust collector and/or a fibrous filter. The aerosol ionization device charges aerosol in the air. The aerosol ionization device may include a discharge electrode and a counter electrode. When a high voltage is applied between the discharge electrode and the counter electrode, corona discharge occurs at the discharge electrode. Aerosol in the air is ionized by using ions generated around the discharge electrode. Accordingly, the efficiency of removing contaminants in the dust collector may be improved.

### DISCLOSURE OF INVENTION

### Solution to Problem

An aerosol ionization device of the present disclosure includes a discharge electrode and a counter electrode. The discharge electrode includes a spun yarn including electrically-conductive metal staple fibers. Ends of at least some of the electrically-conductive metal staple fibers protrude from a surface of the spun yarn. The counter electrode faces the discharge electrode with a gap therebetween

An air purifier of the present disclosure includes the aerosol ionization device for charging aerosol in air. A dust collection unit is disposed at a downstream side of the ionization device to collect the aerosol A blower is configured to form an airflow passing through the aerosol ionization device and the dust collection unit. A high-voltage generator is configured to supply a high voltage to the aerosol ionization device.

### BRIEF DESCRIPTION OF DRAWINGS

FIG. 1 is a schematic diagram illustrating an air purifier, according to an embodiment of the present disclosure.

FIG. 2 is a schematic diagram illustrating an air purifier, according to an embodiment of the present disclosure.

FIG. 3 is a schematic diagram illustrating an embodiment of a discharge unit of FIGS. 1 and 2.

FIG. 4 is a schematic diagram illustrating an embodiment of the discharge unit of FIGS. 1 and 2.

FIG. 5A is a schematic view illustrating an example of a spun yarn in the form of a single spun yarn, according to an embodiment of the present disclosure.

FIGS. 5B, 50, 5D, and 5E are schematic cross-sectional views illustrating the spun yarn of FIG. 5A, according to an embodiment of the present disclosure.

FIG. 6A is a schematic view illustrating an example of a spun yarn in the form of a multiple plies yarn, according to an embodiment of the present disclosure.

FIGS. 6B, 6C, 6D, and 6E are schematic cross-sectional views illustrating the spun yarn of FIG. 6A, according to an embodiment of the present disclosure.

FIG. 7A is a schematic view illustrating an example of a spun yarn in the form of a core-spun yarn, according to an embodiment of the present disclosure.

FIGS. 7B, 7C, 7D, and 7E are schematic cross-sectional views illustrating the spun yarn of FIG. 7A, according to an embodiment of the present disclosure.

FIGS. 8A and 8B are views schematically illustrating a discharge region of a tungsten wire discharge electrode and a discharge region of a discharge electrode according to an embodiment of the present disclosure.

FIG. 9 is a graph illustrating a result of comparing and evaluating the amounts of ozone generated by a tungsten wire discharge electrode and a discharge electrode, according to an embodiment of the present disclosure.

FIG. 10 is a graph illustrating a result of evaluating charging efficiency according to a diameter of electrically-conductive metal staple fibers, according to an embodiment of the present disclosure.

FIG. 11 is a graph illustrating a result of evaluating charging efficiency according to a diameter of a spun yarn constituting a discharge electrode, according to an embodiment of the present disclosure.

FIG. 12 is a schematic exploded perspective view illustrating an embodiment of an aerosol ionization device of the present disclosure.

FIG. 13 is a partial perspective view illustrating an example of a connection structure between a discharge electrode and a discharge hub, according to an embodiment of the present disclosure.

FIG. 14 is a partial perspective view illustrating an example of a structure for guiding a discharge electrode in a U shape, according to an embodiment of the present disclosure.

FIG. 15 is a schematic view illustrating an example of a connection structure between a discharge electrode and a discharge hub, according to an embodiment of the present disclosure.

FIG. 16 is a schematic view illustrating an example of a connection structure between a discharge electrode and a discharge hub, according to an embodiment of the present disclosure.

### MODE FOR THE INVENTION

Various embodiments and the terms used herein are not intended to limit the technological features set forth herein to particular embodiments and include various changes, equivalents, or replacements for a corresponding embodiment.

In relation to the description of drawings, similar or related reference numerals may denote similar elements.

A singular form of a noun corresponding to an item may include one or more items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, the term “and/or” includes any and all combinations of one or more of the associated listed items.

As used herein, such terms as “1st” and “2nd,” or “first” and “second” may be used to simply distinguish a corresponding component from another, and does not limit the components in another aspect (e.g., importance or order).

When an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

Further, as used in this specification, the terms “include,” “have” and their conjugates may be construed to denote a feature, number, step, operation, constituent element, component, or a combination thereof, but may not be construed to exclude the existence or addition of one or more other features, numbers, steps, operations, constituent elements, components, or combinations thereof.

When a component is referred to as being “connected to”, “coupled to”, “supported by”, or “in contact with” another component, this includes not only a case where the component is directly connected, coupled, supported, or in contact, but also a case where the component is indirectly connected, coupled, supported, or in contact through a third component.

When a component is referred to as being “on” another component, this includes not only a case where the component is in contact with the other component, but also a case where another component exists between the two components.

An air purifier may include an aerosol ionization device. A field charging method and a diffusion charging method may be applied to the aerosol ionization device. In the field charging method, a conductive metal wire such as tungsten may be used as a discharge electrode. In the diffusion charging method, a carbon fiber assembly may be used as a discharge electrode.

The field charging method has the advantage of uniformly charging aerosol within a limited space. However, in order to generate stable ions by using a metal wire having a diameter of about 70 μm to about 150 μm, high current may be required and thus, a large amount of ozone may be generated. Also, due to reverse sputtering during corona discharge, SiO₂ formed by a combination of silicon components and oxygen in the air may be coated on a surface of the metal wire. This may cause a decrease in discharge efficiency. Also, because the metal wire has low elongation and is susceptible to damage due to deformation caused by twisting or bending of the wire, it is difficult to form a zigzag discharge electrode by bending one metal wire several times. Also, in order to be used as the discharge electrode, tension needs to be applied to the metal wire. Accordingly, a plurality of metal wires having a certain length are required, and each of the plurality of metal wires should be connected to a discharge hub by using a ring terminal and a spring. Accordingly, the number of components for forming the discharge electrode may increase, and the number of processes for connection to the discharge hub may increase, thereby increasing material costs and manufacturing costs.

The present disclosure provides an aerosol ionization device capable of effectively charging aerosol within a limited space. The present disclosure provides an ionization device capable of reducing ozone generation. The present disclosure provides an aerosol ionization device capable of reducing a decrease in discharge efficiency caused by contamination of a discharge electrode. The present disclosure provides an aerosol ionization device capable of easily removing contamination on a discharge electrode. The present disclosure provides an aerosol ionization device capable of reducing the number of components required to install a discharge electrode. The present disclosure provides an aerosol ionization device capable of reducing manufacturing process costs. The present disclosure provides an air purifier employing an aerosol ionization device. However, technical problems to be solved by the present disclosure are not limited to the above technical problems, and other unmentioned technical problems may be clearly understood by one of ordinary skill in the art from the following description.

Hereinafter, exemplary embodiments of an aerosol ionization device and an air purifier employing the same according to the present disclosure will be described in detail with reference to the accompanying drawings. The same reference numerals or symbols shown in the drawings denote parts or components that perform substantially the same functions.

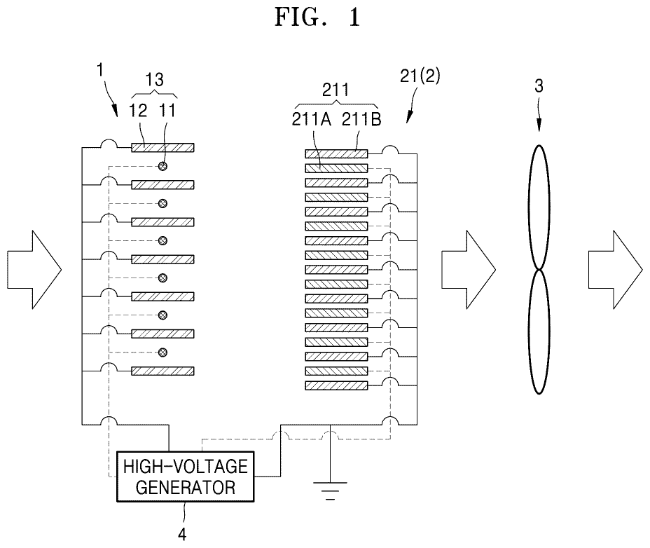

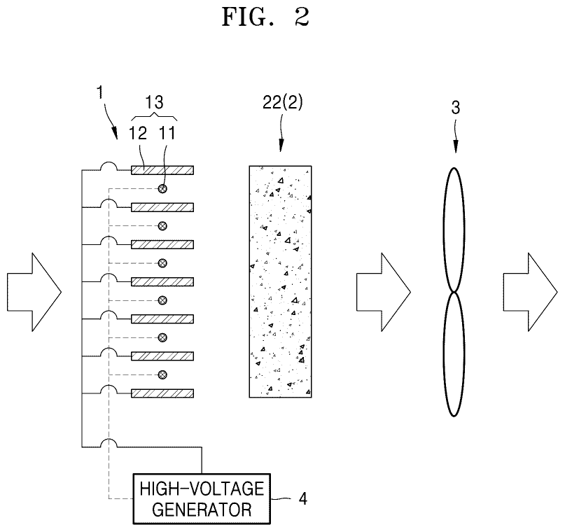

FIGS. 1 and 2 are schematic diagrams illustrating an air purifier, according to an embodiment of the present disclosure. Referring to FIGS. 1 and 2, the air purifier may include an aerosol ionization device 1, a dust collection unit 2, and a blower 3. The blower 3 forms an airflow passing through the aerosol ionization device 1 and the dust collection unit 2. Based on a direction of the airflow, the dust collection unit 2 may be located at a downstream side of the aerosol ionization device 1. The blower 3 may be disposed at an upstream side of the aerosol ionization device 1, between the aerosol ionization device 1 and the dust collection unit 2, or at a downstream side of the dust collection unit 2. In the present embodiment, the blower 3 is disposed at the downstream side of the dust collection unit 2. A high-voltage generator 4 supplies a high voltage to the aerosol ionization device 1 and an electric dust collector 21 (see FIG. 1).

The aerosol ionization device 1 charges aerosol, for example, dust, in the air drawn inside by the blower 3. A detailed structure of the aerosol ionization device 1 will be described below.

The dust collection unit 2 is disposed at the downstream side of the ionization device 1 to collect aerosol. The electric dust collector 21 (see FIG. 1), a fibrous filter 22 (see FIG. 2), or a combination thereof may be employed as the dust collection unit 2. The electric dust collector 21 may include a plurality of dust collection electrode pairs 211. Each dust collection electrode pair 211 includes a dust collection electrode 211A and a second dust collection electrode 211B facing each other. For example, a high voltage may be applied to the first dust collection electrode 211A, and the second dust collection electrode 211B may be grounded. Due to a potential difference between the first and second dust collection electrodes 211A and 211B, charged aerosol may be captured by the first and second dust collection electrodes 211A and 211B with high dust collection efficiency. Due to electrostatic attraction, aerosol may be captured on surfaces of fibers constituting the fibrous filter 22. Aerosol charged by the aerosol ionization device 1 may be captured not only on the surfaces of the fibers but also in chain forms on aerosol already captured on the surfaces of the fibers, thereby improving dust collection efficiency.

The blower 3 generates an airflow passing through the aerosol ionization device 1 and the dust collection unit 2. Air drown into the air purifier by the blower 3 passes through the aerosol ionization device 1 and the dust collection unit 2 and then is discharged outside the air purifier. A type of the blower 3 is not particularly limited.

The aerosol ionization device 1 ionizes aerosol in the air. The aerosol ionization device 1 of the present disclosure charges aerosol in the air drawn inside by using corona discharge. Referring to FIGS. 1 and 2, the aerosol ionization device 1 may include a discharge electrode 11, and a counter electrode 12 facing the discharge electrode 11 with a gap therebetween. In the present embodiment, the discharge electrode 11 is located between one pair of counter electrodes 12. A high voltage, for example, from the high-voltage generator 4, is applied to the discharge electrode 11. The counter electrode 12 may be grounded. The discharge electrode 11 and the counter electrode 12 constitute a discharge unit 13 that generates corona discharge.

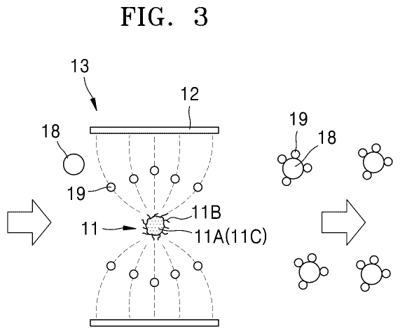

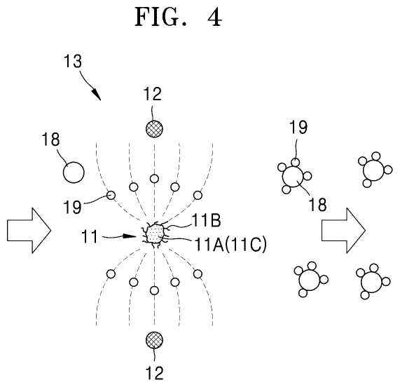

FIGS. 3 and 4 are schematic diagrams illustrating an embodiment of the discharge unit 13 of FIGS. 1 and 2. Referring to FIGS. 3 and 4, the discharge electrode 11 may include a spun yarn 11C formed by twisting a plurality of fibers. The plurality of fibers may include electrically-conductive metal staple fibers 11A. A length of the electrically-conductive metal staple fibers 11A is not particularly limited, and may be, for example, 100 mm or less. For example, a length of the electrically-conductive metal staple fibers 11A may be about 20 mm to about 100 mm. In an embodiment, the electrically-conductive metal staple fibers 11A may include staple fibers formed of stainless steel. Ends 11B of at least some of the electrically-conductive metal staple fibers 11A protrude from an outer surface of the spun yarn 11C. Corona discharge occurs at the protruding ends 11B. The counter electrode 12 may be an electrically-conductive plate electrode as shown in FIG. 3. The counter electrode 12 may be an electrically-conductive wire electrode as shown in FIG. 4.

The spun yarn 11C and the counter electrode 12 are spaced apart from each other. In order to prevent spark discharge due to dielectric breakdown of air between the spun yarn 11C and the counter electrode 12, a separation distance between the spun yarn 11C and the counter electrode 12 may be greater than or equal to a clearance distance. When the separation distance between the spun yarn 11C and the counter electrode 12 is too small, because a greater number of spun yarns 11C and counter electrodes 12 are disposed in a given cross-sectional air passage, the cost of the ionization device 1 may increase. When the separation distance between the spun yarn 11C and the counter electrode 12 is too large, a relatively high voltage may be required and ionization efficiency may be reduced. Considering this, the separation distance between the spun yarn 11C and the counter electrode 12 may be set to about 15 mm to about 30 mm. For example, the separation distance between the spun yarn 11C and the counter electrode 12 may be about 20 mm.

A high voltage may be applied from the high-voltage generator 4 to the spun yarn 11C, and the counter electrode 12 may be grounded. Due to a potential difference between the counter electrode 12 and the protruding ends 11B of the electrically-conductive metal staple fibers 11A, corona discharge occurs at the metal ends 11B of the electrically-conductive metal staple fibers 11A, releasing ions 19. The ions 19 charge aerosol 18 included in air passing through the ionization device 1.

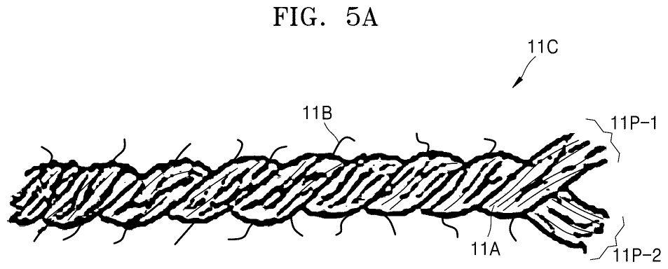

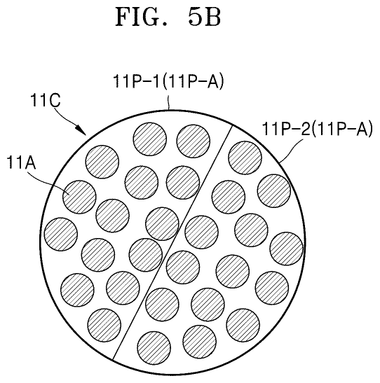

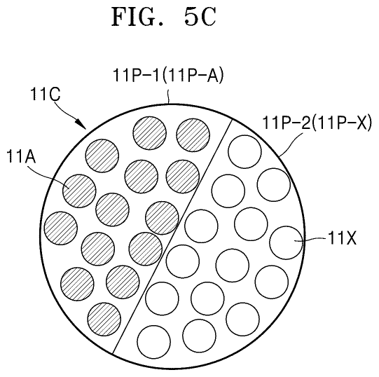

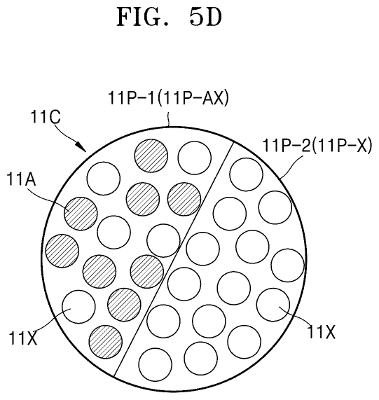

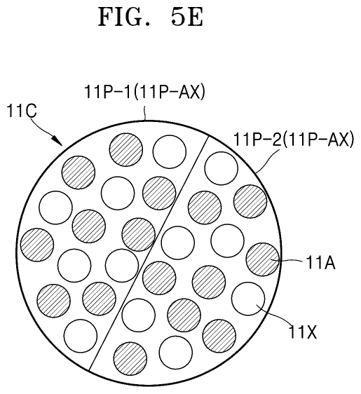

The spun yarn 11C may include the electrically-conductive metal staple fibers 11A. The spun yarn 11C may further include other fibers 11X (see FIGS. 5 to 7). The other fibers 11X may include control fibers for adjusting the number and density of the ends 11B of the electrically-conductive metal staple fibers 11A protruding from the surface of the spun yarn 11C (where the density refers to the number of the protruding ends 11B per unit length of the spun yarn 11C). The control fibers may include filament fibers, staple fibers, or a combination thereof. When the control fibers are staple fibers, the control fibers may be electrically insulating fibers. Even when ends of the electrically insulating fibers protrude from the surface of the spun yarn 11C, the electrically insulating fibers do not function as effective discharge points. When the spun yarn 11C is manufactured by mixing the electrically-conductive metal staple fibers 11A with staple-type control fibers, the number and density of the ends 11B of the electrically-conductive metal staple fibers 11A protruding from the surface of the spun yarn 11C may be adjusted. Filament fibers form few or no protruding ends 11B. Accordingly, when the control fibers are filament fibers, the control fibers may be electrically conductive or electrically insulating fibers. A material of filament-type control fibers having electrical conductivity is not particularly limited, and may be, for example, the same as or different from that of the electrically-conductive metal staple fibers 11A. In order to reduce or prevent oxidation during cleaning of the spun yarn 11C, the filament-type control fibers having electrical conductivity may be formed of a material that is resistant to oxidation during cleaning, for example, stainless steel. The electrically insulating control fibers may be, for example, polymer fibers.

The other fibers 11X may include reinforcing fibers for reinforcing a strength of the spun yarn 11C, for example, a tensile strength. The reinforcing fibers may include filament fibers, staple fibers, or a combination thereof. When the reinforcing fibers are staple fibers, the reinforcing fibers may be electrically insulating fibers. When the reinforcing fibers are filament fibers, the reinforcing fibers may be electrically conductive or electrically insulating fibers. Accordingly, the strength of the spun yarn 11C may be reinforced without affecting the number or density of the ends 11B of the electrically-conductive metal staple fibers 11A protruding from the surface of the spun yarn 11C.

A type of the spun yarn 11C constituting the discharge electrode 11 is not particularly limited. For example, the spun yarn 11C may be of any of various types such as a single spun yarn, a multiple plies yarn, or a core-spun yarn. Hereinafter, various examples of the spun yarn 11C will be described with reference to FIGS. 5 to 7.

FIG. 5A is a schematic view illustrating an example of the spun yarn 11C in the form of a single spun yarn. FIGS. 5B, 5C, 5D, and 5E are schematic cross-sectional views illustrating the spun yarn 11C of FIG. 5A. Referring to FIG. 5A, the spun yarn 11C may be a single spun yarn formed by twisting two plies 11P-1 and 11P-2. As shown in FIGS. 5B to 5E, at least one of the plies 11P-1 and 11P-2 may include the electrically-conductive metal staple fibers 11A. In an embodiment, in order to adjust the number and density of the protruding ends 11B or reinforce a strength of the spun yarn 11C, at least one of the plies 11P-1 and 11P-2 may include the other fibers 11X.

For example, as shown in FIG. 5B, both plies 11P-1 and 11P-2 may be plies 11P-A formed of the electrically-conductive metal staple fibers 11A. As shown in FIG. 5C, the ply 11P-1 may be the ply 11P-A formed of the electrically-conductive metal staple fibers 11A, and the ply 11P-2 may be a ply 11P-X formed of the other fibers 11X. As shown in FIG. 5D, the ply 11P-1 may be a ply 11P-AX formed of the electrically-conductive metal staple fibers 11A and the other fibers 11X, and the ply 11P-2 may be the ply 11P-X formed of the other fibers 11X. As shown in FIG. 5E, both plies 11P-1 and 11P-2 may be the plies 11P-AX formed of the electrically-conductive metal staple fibers 11A and the other fibers 11X.

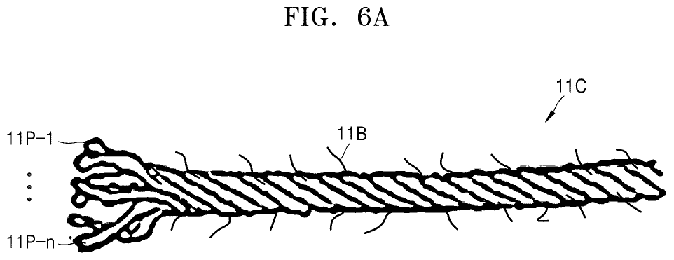

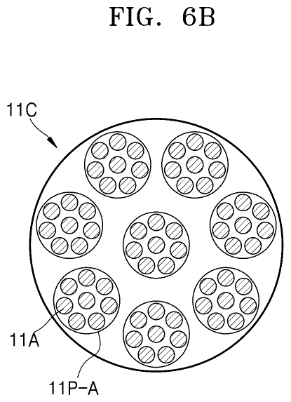

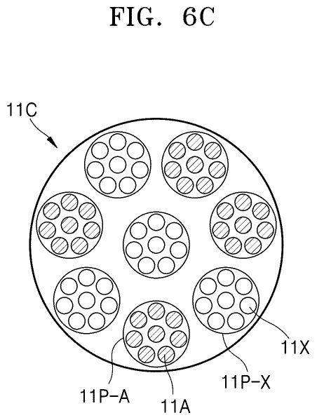

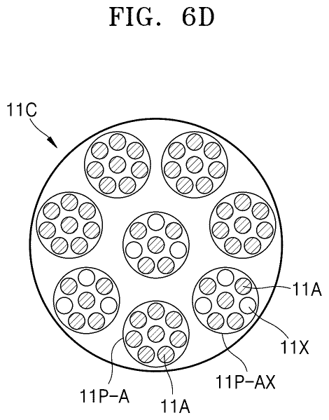

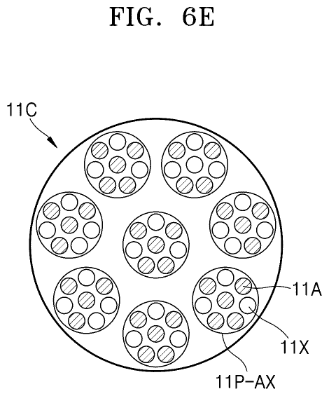

FIG. 6A is a schematic view illustrating an example of the spun yarn 11C in the form of a multiple plies yarn. FIGS. 6B, 6C, 6D, and 6E are schematic cross-sectional views illustrating the spun yarn 11C of FIG. 6A. Referring to FIGS. 6A to 6E, the spun yarn 11C may be a multiple plies yarn formed by twisting three or more plies 11P-1 to 11P-n. At least one of the plurality of plies 11P-1 to 11P-n may include the electrically-conductive metal staple fibers 11A. In an embodiment, at least one of the plurality of plies 11P-1 to 11P-n may include the other fibers 11X. In an embodiment, at least one of the plurality of plies 11P-1 to 11P-n may include the electrically-conductive metal staple fibers 11A and the other fibers 11X.

For example, as shown in FIG. 6B, all of the plies 11P-1 to 11P-n may be the plies 11P-A formed of the electrically-conductive metal staple fibers 11A. As shown in FIG. 6C, some of the plies 11P-1 to 11P-n may be the plies 11P-A formed of the electrically-conductive metal staple fibers 11A, and others may be the plies 11P-X formed of the other fibers 11X. As shown in FIG. 6D, some of the plies 11P-1 to 11P-n may be the plies 11P-A formed of the electrically-conductive metal staple fibers 11A, and others may be the plies 11P-AX formed of the electrically-conductive metal staple fibers 11A and the other fibers 11X. As shown in FIG. 6E, all of the plies 11P-1 to 11P-n may be the plies 11P-AX formed of the electrically-conductive metal staple fibers 11A and the other fibers 11X. Alternatively, the plies 11P-1 to 11P-n may be a combination of the plies 11P-A, the plies 11P-X, and the plies 11P-AX, or a combination of the plies 11P-X and the plies 11P-AX.

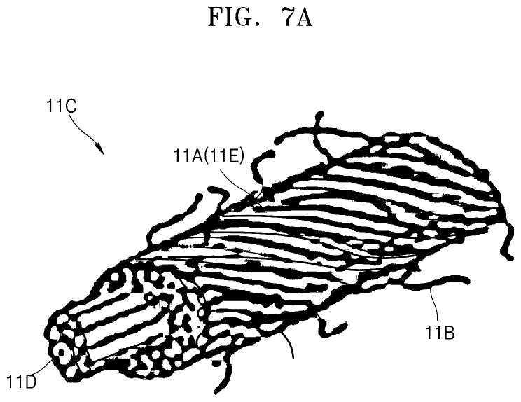

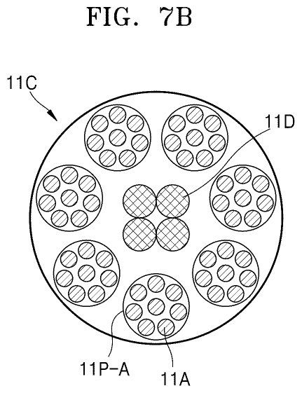

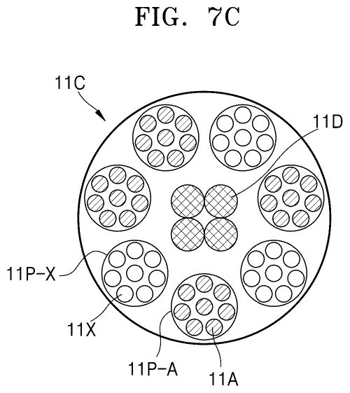

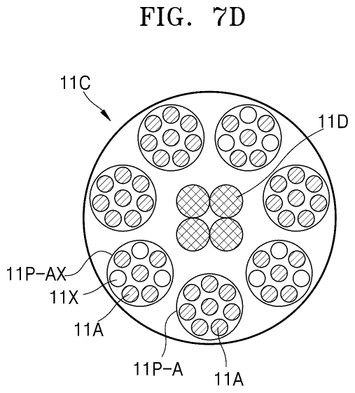

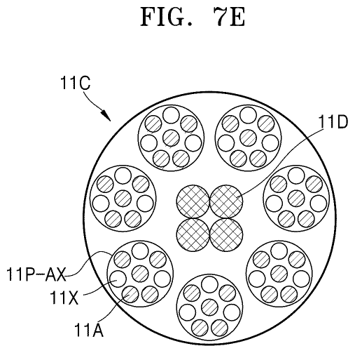

FIG. 7A is a schematic view illustrating an example of the spun yarn 11C in the form of a core-spun yarn. FIGS. 7B, 7C, 7D, and 7E are schematic cross-sectional views illustrating the spun yarn 11C of FIG. 7A. Referring to FIGS. 7A to 7E, the spun yarn 11C may be a core-spun yarn including core fibers 11D and fibers 11E wound around an outer circumference of the core fibers 11D. The core fibers 11D may be electrically conductive or electrically insulating. The core fibers 11D may be filament fibers. Accordingly, a tensile strength of the spun yarn 11C may be improved. The fibers 11E includes the electrically-conductive metal staple fibers 11A. In an embodiment, the fibers 11E may further include the other fibers 11X. The other fibers 11X may be electrically conductive fibers or electrically insulating fibers. The other fibers 11X may be staple fibers or filament fibers. In an embodiment, the fibers 11E may be wound in the form of a single ply or multiple plies around the outer circumference of the core fibers 11D. In an embodiment, at least one of the multiple plies includes the electrically-conductive metal staple fibers 11A. In an embodiment, at least one of the multiple plies may include the other fibers 11X. In an embodiment, at least one of the multiple plies may include the electrically-conductive metal staple fibers 11A and the other fibers 11X.

For example, as shown in FIG. 7B, all of the multiple plies may be the plies 11P-A formed of the electrically-conductive metal staple fibers 11A. As shown in FIG. 7C, some of the multiple plies may be the plies 11P-A formed of the electrically-conductive metal staple fibers 11A, and others may be the plies 11P-X formed of the other fibers 11X. As shown in FIG. 7D, some of the multiple plies may be the plies 11P-A formed of the electrically-conductive metal staple fibers 11A, and others may be the plies 11P-AX formed of the electrically-conductive metal staple fibers 11A and the other fibers 11X. As shown in FIG. 7E, all of the multiple plies may be the plies 11P-AX formed of the electrically-conductive metal staple fibers 11A and the other fibers 11X. Alternatively, the multiple plies may be a combination of the plies 11P-A, the plies 11P-X, and the plies 11P-AX, or a combination of the plies 11P-X and the plies 11P-AX.

A form of the spun yarn 11C is not limited to the above embodiments, and may be any of various forms having an appropriate number of protruding ends 11B with appropriate lengths.

When a protruding length of the ends 11B of the electrically-conductive metal staple fibers 11A from an outer surface of the spun yarn 11C is too long, a distance to the counter electrode 12 may decrease, thereby causing spark discharge. Also, as the protruding length of the ends 11B of the electrically-conductive metal staple fibers 11A from the outer surface of the spun yarn 11C increases, a gap with the counter electrode 12 decreases, thereby reducing a discharge range. Considering these points, the protruding length of the ends 11B of the electrically-conductive metal staple fibers 11A from the outer surface of the spun yarn 11C may be 10 mm or less. For example, the protruding length of the ends 11B of the electrically-conductive metal staple fibers 11A from the outer surface of the spun yarn 11C may be about 0.1 mm to about 10 mm.

A density of the ends 11B of the electrically-conductive metal staple fibers 11A, for example, the number of the protruding ends 11B of the electrically-conductive metal staple fibers 11A per unit length of the spun yarn 1C, may be, for example, one or more per centimeter. When the number of the protruding ends 11B of the electrically-conductive metal staple fibers 11A per unit length of the spun yarn 1C is too small, ionization efficiency may be reduced.

The protruding length of the ends 11B of the electrically-conductive metal staple fibers 11A from the outer surface of the spun yarn 11C, and the number of the protruding ends 11B of the electrically-conductive metal staple fibers 11A per unit length of the spun yarn 1C may be adjusted by a length of the electrically-conductive metal staple fibers 11A, the number of the electrically-conductive metal staple fibers 11A, and a mixing ratio between the electrically-conductive metal staple fibers 11A and the other fibers 11X, for example, control fibers.

By producing a spun yarn by using polymer staple fibers and carbonizing the spun yarn at a high temperature, a discharge electrode in which ends of the carbonized polymer staple fibers protrude from a surface of the spun yarn may be manufactured. Such a conventional discharge electrode requires a complex manufacturing process, consumes significant energy during a carbonization process, and requires a large amount of materials, resulting in high costs. Also, in order to prevent the spun yarn from breaking during the carbonization process, the spun yarn is relatively thick, about 3 mm to about 5 mm. According to the present disclosure, the discharge electrode 11 is implemented by the spun yarn 11C including the electrically-conductive metal staple fibers 11A, for example, stainless steel staple fibers. The discharge electrode 11 in which the ends 11B of the electrically-conductive metal staple fibers 11A protrude from the surface of the spun yarn 11C may be manufactured through a spinning process, without requiring a carbonization process. Accordingly, the discharge electrode 11 may be manufactured at low cost by using a relatively simple manufacturing process with low energy consumption. Also, because there is no carbonization process, the spun yarn 11C having a smaller thickness than the conventional discharge electrode using a carbonization process may be manufactured. According to the discharge electrode 11 of the present disclosure, the discharge unit 13 having the advantages of both field charging and diffusion charging methods may be implemented.

The electrically-conductive metal staple fibers 11A may be, for example, stainless steel staple fibers. The stainless steel may be austenitic stainless steel, for example, STS304 or STS306 specified in the Korean Industrial Standards (KS). However, a type of the electrically-conductive metal staple fibers 11A is not limited thereto.

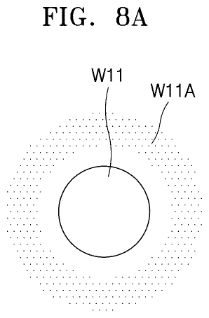

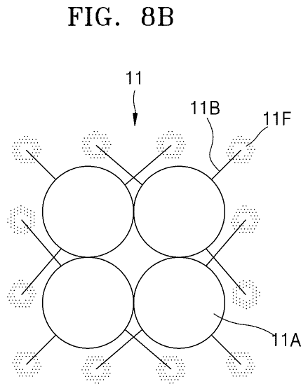

According to the discharge electrode 11 of the present disclosure, ozone generation may be reduced compared to the discharge electrode using a tungsten wire. FIGS. 8A and 8B are views schematically illustrating a discharge region of a tungsten wire discharge electrode and a discharge region of the discharge electrode 11 according to an embodiment of the present disclosure. Referring to FIG. 8A, in the case of a tungsten wire discharge electrode W11, plasma discharge occurs in a region W11A surrounding a tungsten wire having a diameter of about 90 μm. The region W11A extends in a longitudinal direction of the tungsten wire. In contrast, in the case of the discharge electrode 11 according to the present disclosure, plasma discharge occurs in regions 11F around the ends 11B of the electrically-conductive metal staple fibers 11A protruding from an outer surface of the discharge electrode 11 as shown in FIG. 8B. A plurality of regions 11F are intermittently arranged in the longitudinal direction of the discharge electrode 11. This may also be confirmed in corona discharge photographs of the tungsten wire discharge electrode W11 and the discharge electrode 11 according to an embodiment of the present disclosure. As such, in the case of the discharge electrode 11 according to the present disclosure, because sizes of the plasma discharge regions 11F are smaller than the discharge region W11A of the conventional tungsten wire discharge region W11, the amount of ozone generated in an ionization process may be significantly reduced.

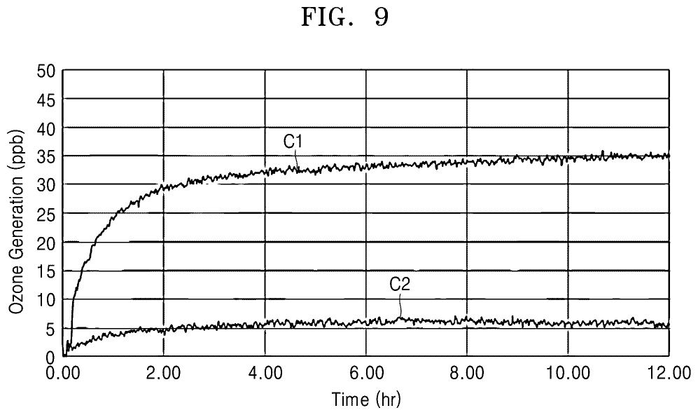

FIG. 9 is a graph illustrating a result of comparing and evaluating the amounts of ozone generated by the tungsten wire discharge electrode W11 and the discharge electrode 11 of the present disclosure. A volume of a measurement chamber is 30 m³. In FIG. 9, C1 represents the amount of ozone generated when the tungsten wire discharge electrode W11 is used, and C2 represents the amount of ozone generated when the discharge electrode 11 of the present disclosure including stainless steel staple fibers is used. Referring to FIG. 9, the amount of ozone generated by the tungsten wire discharge electrode W11 is about 36 parts per billion (ppb), and the amount of ozone generated by the discharge electrode 11 of the present disclosure is about 7 ppb. This is because the plasma discharge regions 11F in the discharge electrode 11 of the present disclosure are greatly reduced compared to the discharge region W11F of the conventional discharge electrode W11.

The discharge electrode 11 may be contaminated during operation of the ionization device 1. Contamination of the discharge electrode 11 may cause a decrease in discharge efficiency. In the case of the conventional discharge electrode using a tungsten wire, due to reverse sputtering during corona discharge, SiO₂ formed by a combination of silicon components and oxygen in the air may be widely coated on a surface of the tungsten wire. Because the coated contaminants strongly adhere to the tungsten wire, even when the contaminated tungsten wire is immersed in a neutral detergent for 30 minutes, vigorously shaken for cleaning, and then rinsed with shower water, the contaminants are not easily removed. According to the present disclosure, the spun yarn 11C including the electrically-conductive metal staple fibers 11A, for example, stainless steel staple fibers, is used as the discharge electrode 11. In the case of the spun yarn 11C having the protruding ends 11B, contamination primarily grows at the protruding ends 11B. Because the contamination may be easily separated from the protruding ends 11B even by a small impact, the contamination may be easily removed by shower water cleaning. Accordingly, a decrease in discharge efficiency due to contamination of the discharge electrode 11 may be easily reduced or prevented.

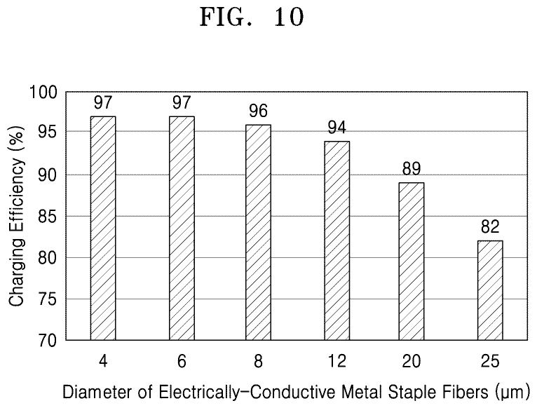

FIG. 10 is a graph illustrating a result of evaluating charging efficiency according to a diameter of the electrically-conductive metal staple fibers 11A. The charging efficiency is a 1-pass dust collection efficiency value of an air purifier. In the evaluation, factors other than the diameter of the electrically-conductive metal staple fibers 11A, for example, a wind speed (1 m/sec), an output current value (40 μA), and a configuration of the dust collection unit 2, are set the same. Because dust collection efficiency depends on charging efficiency, the dust collection efficiency may be regarded as the charging efficiency. Stainless steel staple fibers are used as the electrically-conductive metal staple fibers 11A.

Referring to FIG. 10, when the diameter of the electrically-conductive metal staple fibers 11A ranges from about 4 μm to about 12 μm, the charging efficiency is about 94% or more. When the diameter of the electrically-conductive metal staple fibers 11A is greater than about 20 μm, the charging efficiency is less than 90%. When the diameter of the electrically-conductive metal staple fibers 11A is less than about 4 μm, it is not easy to manufacture the staple fibers themselves, and the number of the electrically-conductive metal staple fibers 11A required to manufacture the discharge electrode 11 is too large, thereby increasing manufacturing costs. When the diameter of the electrically-conductive metal staple fibers 11A is greater than 12 μm, the quality of the manufactured spun yarn 11C is poor. Considering these points, the diameter of the electrically-conductive metal staple fibers 11A may be about 4 μm to about 12 μm, and, for example, about 8 μm.

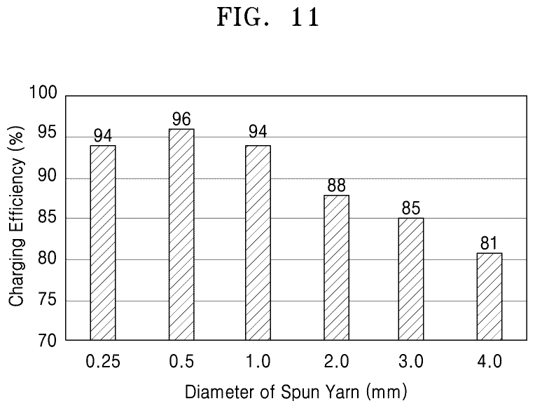

FIG. 11 is a graph illustrating a result of evaluating charging efficiency according to a diameter of the spun yarn 11C constituting the discharge electrode 11. The charging efficiency is a 1-pass dust collection efficiency value of an air purifier. Stainless steel staple fibers having a diameter of about 8 μm are used as the electrically-conductive metal staple fibers 11A. In the evaluation, factors other than the diameter of the spun yarn 11C, for example, a wind speed (1 m/sec), an output current value (40 μA), and a configuration of the dust collection unit 2, are set the same. Because dust collection efficiency depends on charging efficiency, the dust collection efficiency may be regarded as the charging efficiency. The diameter of the spun yarn 11C used in the evaluation is 0.25, 0.5, 1.0, 2.0, 3.0, and 4.0 mm.

Referring to FIG. 11, when the diameter of the spun yarn 11C ranges from about 0.2 mm to about 1.0 mm, the charging efficiency is about 94% or more. When the diameter of the spun yarn 11C is greater than 1.0 mm, as a diameter increases, the charging efficiency tends to decrease. Also, when the diameter of the spun yarn 11C increases, the amount of electrically-conductive metal staple fibers 11A used increases, thereby increasing manufacturing costs. Considering these points, the diameter of the spun yarn 11C may be about 0.2 mm to about 1.0 mm.

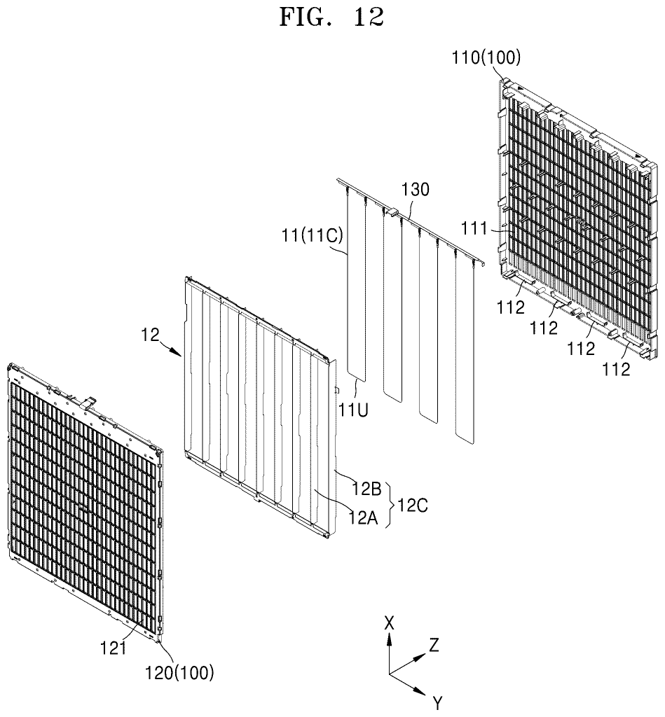

The aerosol ionization device 1 may be implemented in any of various forms. FIG. 12 is a schematic exploded perspective view illustrating an embodiment of the aerosol ionization device 1 of the present disclosure. Referring to FIG. 12, the aerosol ionization device 1 may include the discharge electrode 11 and the counter electrode 12. The discharge electrode 11 may be electrically connected to a discharge hub 130, and a high voltage may be applied to the discharge electrode 11 through the discharge hub 130. The discharge electrode 11, the counter electrode 12, and the discharge hub 130 may be accommodated in a case 100. The case 100 may be formed by coupling a first case 110 and a second case 120 to each other. For example, the discharge electrode 11 and the discharge hub 130 may be accommodated in the first case 110, and the counter electrode 12 may be accommodated in the second case 120. The first case 110 and the second case 120 may be coupled to each other in a first direction Z that is an airflow direction. Air vents 111 and 121 may be respectively provided on surfaces of the first case 110 and the second case 120 in the first direction Z so that air passes therethrough.

In an embodiment, the counter electrode 12 is an electrically conductive plate electrode. The counter electrode 12 may have a quadrangular plate shape having a width in the first direction Z and a length in a second direction X orthogonal to the first direction Z, and a plurality of counter electrodes 12 are arranged to be spaced apart from each other in a third direction Y orthogonal to the first direction Z and the second direction X. The plurality of counter electrodes 12 may be electrically connected to each other. The plurality of counter electrodes 12 may be grounded. A first counter electrode 12A and a second counter electrode 12B facing each other constitute a counter electrode pair 12C. A plurality of counter electrode pairs 12C may be arranged in the third direction Y. For example, in FIG. 12, nine counter electrodes 12 are illustrated, and eight counter electrode pairs 12C are arranged in the third direction Y.

The discharge electrode 11 is a wire electrode. The description of the discharge electrode 11 with reference to FIGS. 1 to 11 applies to the discharge electrode 11 of FIG. 12. Accordingly, the discharge electrode 11 may include the spun yarn 11C formed by twisting a plurality of fibers. The plurality of fibers may include the electrically-conductive metal staple fibers 11A. The electrically-conductive metal staple fibers 11A may include staple fibers formed of stainless steel. The ends 11B of at least some of the electrically-conductive metal staple fibers 11A protrude from an outer surface of the spun yarn 11C.

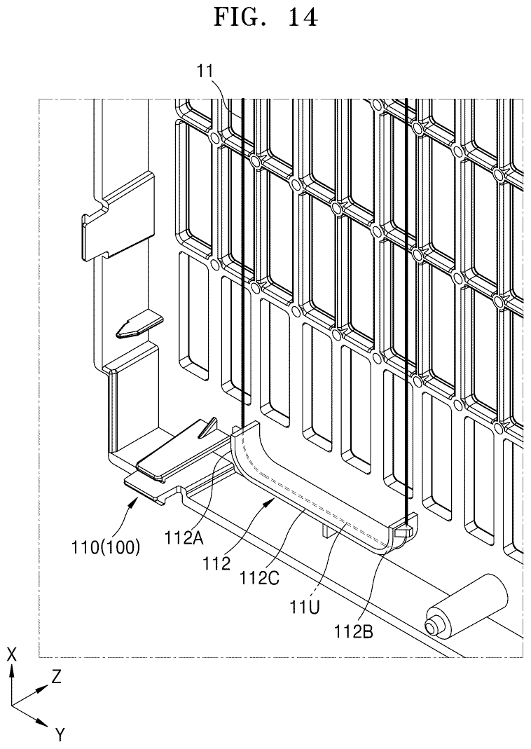

The discharge electrode 11 is disposed between first and second counter electrodes 12A and 12B to be spaced apart from the first and second counter electrodes 12A and 12B. Referring to FIG. 12, for example, one discharge electrode 11 corresponds to two counter electrode pairs 12C. In other words, one discharge electrode 11 may have a U shape. In FIG. 12, four discharge electrodes 11 having a U shape are illustrated. Both ends of the discharge electrode 11 having a U shape are connected to the discharge hub 130, and a bent portion 11U of the discharge electrode 11 having a U shape is guided by a guide portion 112 (see FIG. 14) provided in, for example, the first case 110.

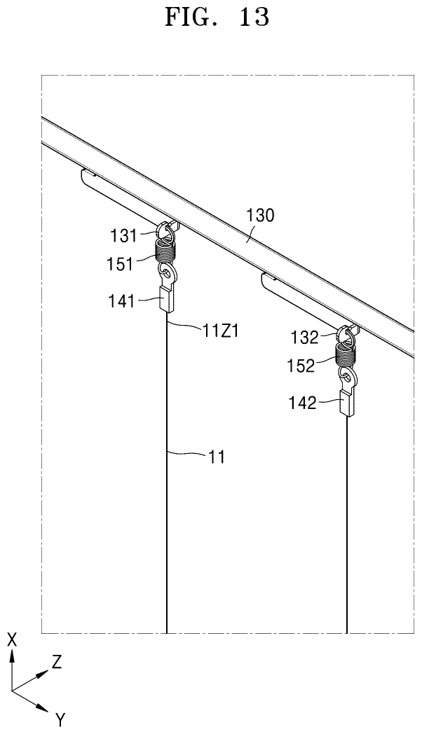

The discharge electrode 11 may be connected to the discharge hub 130 by at least one ring terminal and a spring. The spring applies tension to the discharge electrode 11. FIG. 13 is a partial perspective view illustrating an example of a connection structure between the discharge electrode 11 and the discharge hub 130. FIG. 14 is a partial perspective view illustrating an example of a structure for guiding the discharge electrode 11 in a U shape. First, referring to FIG. 13, a ring terminal 141 is connected to one end 11Z1 of the discharge electrode 11. The ring terminal 141 is connected to the discharge hub 130 by a spring 151. For example, a locking portion 131 with which the spring 151 is engaged may be provided on the discharge hub 130. The spring 151 may be, for example, a tension coil spring. One end of the spring 151 is connected to the ring terminal 141, and the other end is engaged with the locking portion 131 of the discharge hub 130.

Next, referring to FIG. 14, the guide portion 112 is provided near a lower end of the first case 110 in the second direction X, that is, an end opposite to an end where the discharge hub 130 is disposed. In an embodiment, the guide portion 112 may include one pair of first guide portions 112A and 112B extending in an extension direction of the discharge electrode 11, that is, in the second direction X, and spaced apart from each other by a pitch of two counter electrode pairs 12C, that is, an interval between the two counter electrode pairs 12C in the third direction Y, and a second guide portion 112C connecting ends of the pair of first guide portions 112A and 112B.

As shown in FIG. 13, the end 11Z1 of the discharge electrode 11 is connected to the discharge hub 130 by the ring terminal 141 and the spring 151. The discharge electrode 11 extends from the end 11Z1, for example, in a-X direction. As shown in FIG. 14, the discharge electrode 11 is sequentially guided by the first guide portion 112A, the second guide portion 112C, and the first guide portion 112B, is bent into a U shape, and extends in a +X direction.

The other end 11Z2 of the discharge electrode 11 may be connected to the discharge hub 130. A connection structure between the other end 11Z2 of the discharge electrode 11 and the discharge hub 130 is not particularly limited. For example, referring to FIG. 13, a ring terminal 142 may be connected to the other end 11Z2 of the discharge electrode 11. The ring terminal 142 may be connected to a locking portion 132 provided on the discharge hub 130 via a spring 152. The spring 152 may be, for example, a tension coil spring. Although not shown, the other end 11Z2 of the discharge electrode 11 may be directly connected to the discharge hub 130 without the spring 152. Although not shown, the other end 11Z2 of the discharge electrode 11 may be connected to the first case 110.

According to the present disclosure, because the discharge electrode 11 implemented by the spun yarn 11C has relatively high flexibility compared to a tungsten wire, the discharge electrode 11 may be bent into a U shape as shown in FIGS. 12 to 14. The number of the discharge electrodes 11 required is half the number of the counter electrode pairs 12C. Accordingly, because the ionization device 1 may be implemented with a smaller number of discharge electrodes 11, the number of ring terminals and the number of springs may be reduced, and the number of processes of connecting the discharge electrodes 11 to the discharge hub 130 may be reduced, thereby reducing material costs and manufacturing costs. Also, due to the relatively high flexibility of the spun yarn 11C, the workability of connecting the discharge electrodes 11 to the discharge hub 130 may be improved.

A shape of the discharge electrode 11 is not limited to a U shape. Because the discharge electrode 11 implemented by the spun yarn 11C has high flexibility and thus has a relatively low risk of damage due to deformation such as bending compared to a tungsten wire, the discharge electrode 11 may have various shapes including two or more bent portions. The discharge electrode 11 may have various shapes. Hereinafter, an embodiment of the discharge electrode 11 having two bent portions and an embodiment of the discharge electrode 11 having three bent portions will be described.

The discharge electrode 11 may have various shapes. FIG. 15 is a schematic view illustrating an example of a connection structure between the discharge electrode 11 and the discharge hub 130. Referring to FIG. 15, the discharge electrode 11 may have three bent portions 11U1, 11U2, and 11U3 between the end 11Z1 and the other end 11Z2. The three bent portions 11U1, 11U2, and 11U3 are guided by guide portions 112-1, 112-2, and 112-3, respectively. The guide portions 112-1, 112-2, and 112-3 are the same as the guide portion 112 described with reference to FIG. 14, and the guide portion 112-2 has a shape obtained by rotating the guide portion 112 described with reference to FIG. 14 by 180 degrees. Accordingly, the discharge electrode 11 has a substantially W shape. The discharge electrode 11 having a W shape may correspond to four counter electrode pairs 12C. Accordingly, the number of ring terminals and springs may be further reduced. In FIG. 15, the spring 152 may be omitted. In FIG. 15, the other end 11Z2 of the discharge electrode 11 may be connected to the first case 110.

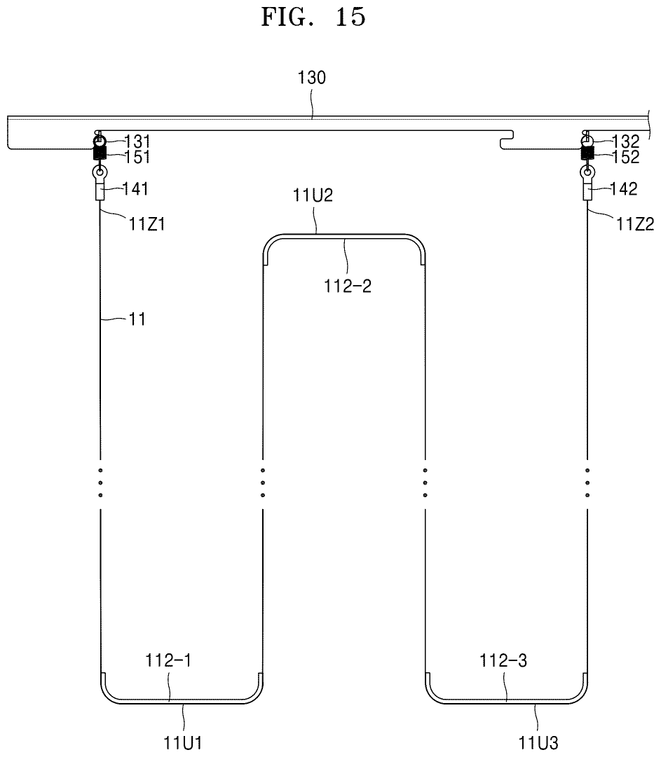

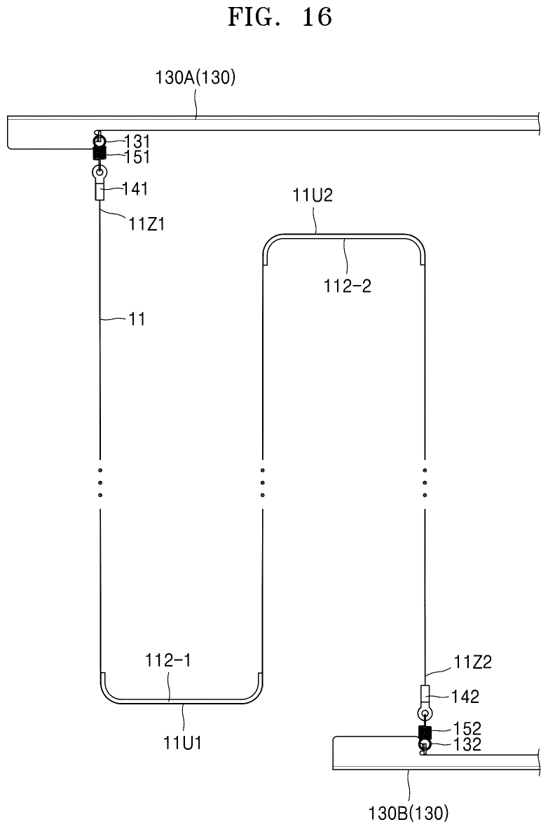

FIG. 16 is a schematic view illustrating an example of a connection structure between the discharge electrode 11 and the discharge hub 130. Referring to FIG. 16, the discharge electrode 11 may have two bent portions 11U1 and 11U2 between the end 11Z1 and the other end 11Z2. The two bent portions 11U1 and 11U2 are respectively guided by the guide portions 112-1 and 112-2. The discharge hub 130 may include a first discharge hub 130A and a second discharge hub 130B. The first and second discharge hubs 130A and 130B are spaced apart from each other in an extension direction of the discharge electrode 11, that is, the second direction X. The end 11Z1 of the discharge electrode 11 may be connected to the first discharge hub 130A via the ring terminal 141 and the spring 151. The other end 11Z2 of the discharge electrode 11 may be connected to the second discharge hub 130B via the ring terminal 142 and the spring 152.

Accordingly, the discharge electrode 11 has a substantially Z shape. The discharge electrode 11 having a Z shape may correspond to three counter electrode pairs 12C. Accordingly, the number of ring terminals and springs may be reduced. The spring 152 may be omitted. The second discharge hub 130B may be omitted, and the other end 11Z2 of the discharge electrode 11 may be connected to the first case 110.

As described above, fibers constituting the discharge electrode 11 of the present disclosure may include the electrically-conductive metal staple fibers 11A and electrically insulating fibers. Accordingly, the number and density of the ends 11B of the electrically-conductive metal staple fibers 11A protruding from a surface of the spun yarn 11C may be adjusted. Also, because electrically conductive or electrically insulating filament fibers are included as reinforcing fibers, a tensile strength of the discharge electrode 11 may be reinforced. The discharge electrode 11 may be installed in any of various shapes such as a U shape, a W shape, or a Z shape.

Shapes and arrangements of the discharge electrode 11 and the counter electrode 12 are not limited to the embodiments described above, and may vary according to a cross-sectional shape of an air passage.

As such, according to the ionization device 1 of the present disclosure, the discharge electrode 11 in the form of the spun yarn 11C including the electrically-conductive metal staple fibers 11A, for example, stainless steel staple fibers, is employed. Accordingly, in a discharge unit structure using a field charging method, material costs may be reduced and workability may be improved. Also, the advantages of the field charging method and a diffusion charging method may be combined with each other. That is, because the discharge structure of the field charging method is adopted while plasma discharge of the diffusion charging method occurs simultaneously, ions may be efficiently generated within a limited space, thereby reducing the amount of ozone generated compared to a conventional field charging method using a tungsten wire. Also, because contamination is limited to the ends 11B of the electrically-conductive metal staple fibers 11A, the contamination may be removed by simple cleaning.

Although various embodiments of the ionization device 1 applied to an air purifier have been descried, the ionization device 1 may be applied to various other devices. For example, the ionization device 1 may be applied to household and industrial air conditioners such as air conditioners and heaters, and industrial dust collection devices.

According to an aspect of the present disclosure, an aerosol ionization device includes a discharge electrode including a spun yarn including electrically-conductive metal staple fibers, wherein ends of at least some of the electrically-conductive metal staple fibers protrude from a surface of the spun yarn, and a counter electrode facing the discharge electrode with a gap therebetween.

In an embodiment, the electrically-conductive metal staple fibers may include stainless steel staple fibers.

In an embodiment, a protruding length of the ends of the electrically-conductive metal staple fibers from the surface of the spun yarn may be 0.1 mm to 10 mm.

In an embodiment, a number of protruding ends of the electrically-conductive metal staple fibers per unit length of the spun yarn may be one or more per centime.

In an embodiment, a diameter of the electrically-conductive metal staple fibers may be 4 μm to 12 μm.

In an embodiment, a diameter of the spun yarn may be 0.2 mm to 1 mm.

In an embodiment, the counter electrode may include a counter electrode pair including a first counter electrode and a second counter electrode facing each other. The discharge electrode may be disposed between the first counter electrode and the second counter electrode.

In an embodiment, the counter electrode may include a plurality of counter electrode pairs. In an embodiment, the discharge electrode may include a plurality of discharge electrodes each corresponding to two or more counter electrode pairs.

In an embodiment, the aerosol ionization device may further include: a discharge hub; a ring terminal provided at an end of the discharge electrode; and a spring electrically connecting the discharge hub to the ring terminal and applying tension to the discharge electrode.

In an embodiment, the spun yarn may further include other fibers.

In an embodiment, the other fibers may include control fibers for adjusting a number and density of protruding ends of the electrically-conductive metal staple fibers.

In an embodiment, the other fibers may include reinforcing fibers for reinforcing a strength of the spun yarn.

In an embodiment, the other fibers may be electrically insulating fibers, wherein the other fibers are any one of filament fibers, staple fibers, and a combination thereof.

In an embodiment, the other fibers may be electrically conductive fibers, wherein the other fibers are filament fibers.

In an embodiment, the spun yarn may be a single yarn.

In an embodiment, the spun yarn may be a multiple plies yarn.

In an embodiment, the spun yarn may be a core-spun yarn in which fibers including the electrically-conductive metal staple fibers are wound around an outer circumference of core fibers.

According to an aspect of the present disclosure, an air purifier includes: the aerosol ionization device for charging aerosol in air; a dust collection unit disposed at a downstream side of the ionization device to collect the aerosol; a blower configured to form an airflow passing through the aerosol ionization device and the dust collection unit; and a high-voltage generator configured to supply a high voltage to the aerosol ionization device.

However, technical effects to be achieved by the present disclosure are not limited those described above, and other technical effects not described herein will be clearly understood by one of ordinary skill in the art based on the description herein.

Although embodiments have been described in detail above, the scope of the present disclosure is not limited thereto, and various modifications and improvements made by one of ordinary skill in the art, by using the basic concept of the present disclosure defined by the claims, are also within the scope of the present disclosure.

1. An aerosol ionization device comprising:
a discharge electrode including a spun yarn, which includes electrically-conductive metal staple fibers, ends of at least some of the electrically-conductive metal staple fibers protruding from a surface of the spun yarn; and
a counter electrode facing the discharge electrode with a gap therebetween.

2. The aerosol ionization device of claim 1, wherein the electrically-conductive metal staple fibers comprise stainless steel staple fibers.

3. The aerosol ionization device of claim 1, wherein a length by which the ends of at least some of the electrically-conductive metal staple fibers protrude from the surface of the spun yarn is 0.1 mm to 10 mm.

4. The aerosol ionization device of claim 1, wherein a number of the ends of at least some of the electrically-conductive metal staple fibers that protrude per unit length of the spun yarn is one or more per centimeter.

5. The aerosol ionization device of claim 1, wherein a diameter of the electrically-conductive metal staple fibers is 4 μm to 12 μm.

6. The aerosol ionization device of claim 1, wherein a diameter of the spun yarn is 0.2 mm to 1 mm.

7. The aerosol ionization device of claim 1, wherein
the counter electrode is a first counter electrode of a counter electrode pair which includes a second counter electrode which faces the first counter electrode, and
the discharge electrode is between the first counter electrode and the second counter electrode.

8. The aerosol ionization device of claim 1, further comprising:
a discharge hub;
a ring terminal at an end of the discharge electrode; and
a spring electrically connectable to the discharge hub to the ring terminal such that the spring applies tension to the discharge electrode while the spring is connected to the discharge hub.

9. The aerosol ionization device of claim 1, wherein the spun yarn further comprises other fibers.

10. The aerosol ionization device of claim 9, wherein the other fibers comprise control fibers to adjust a number and density of the ends of at least some of the electrically-conductive metal staple fibers.

11. The aerosol ionization device of claim 9, wherein the other fibers comprise reinforcing fibers to reinforce a strength of the spun yarn.

12. The aerosol ionization device of claim 9, wherein the other fibers are electrically insulating fibers,
wherein the other fibers are any one of filament fibers, staple fibers, and a combination thereof.

13. The aerosol ionization device of claim 9, wherein the other fibers are electrically conductive fibers,
wherein the other fibers are filament fibers.

14. The aerosol ionization device of claim 1, wherein the spun yarn is a single yarn, a multiple plies yarn, or a core-spun yarn in which fibers comprising the electrically-conductive metal staple fibers are wound around an outer circumference of core fibers.

15. An air purifier comprising:
the aerosol ionization device according to claim 1 to charge aerosol in air;
a dust collection unit at a downstream side of the aerosol ionization device to collect the aerosol;
a blower configured to form an airflow passing through the aerosol ionization device and the dust collection unit; and
a high-voltage generator configured to supply a high voltage to the aerosol ionization device.
